(19) United States
(12) Patent Application Publication
(10) Pub. No.: US 2025/0166580 A1
(43) Pub. Date: May 22, 2025

(54) IMAGE DISPLAY CONTROL DEVICE, IMAGE DISPLAY SYSTEM AND IMAGE DISPLAY CONTROL METHOD

(71) Applicant: Socionext Inc., Kanagawa (JP)

(72) Inventors: Shinichi TOMIOKA, Yokohama (JP); Nobutaka YAMAGISHI, Yokohama (JP)

(21) Appl. No.: 19/033,122

(22) Filed: Jan. 21, 2025

Related U.S. Application Data
(63) Continuation of application No. PCT/JP2022/029076, filed on Jul. 28, 2022.

(51) Int. Cl. G09G 3/34; G09G 3/20; G09G 3/36

(52) U.S. Cl. CPC G09G 3/3426; G09G 3/2092; G09G 3/3611; G09G 2320/0233; G09G 2320/0238; G09G 2320/0242; G09G 2320/0686; G09G 2320/0693; G09G 2330/023; G09G 2354/00

(57) ABSTRACT

An image display control device having a local dimming function, includes a luminance control unit to generate backlight control information used for controlling light sources included in a backlight based on first image information, a pixel compensation unit to generate second image information indicating an output image by correcting pixel values included in the first image information, a first statistics acquisition unit to acquire first statistical data of the pixel values, a second statistics acquisition unit to acquire second statistical data of luminance values, the luminance values corresponding to the light sources, and an abnormality detection unit to detect an abnormality of the luminance control unit according to whether or not the second statistical data is included in a range between an upper limit value and a lower limit value, the upper limit value and the lower limit value being determined by the first statistical data.

This application is a continuation application of International Application No. PCT/JP2022/029076, filed on Jul. 28, 2022, and designated the U.S., the entire contents of which are incorporated herein by reference.

### BACKGROUND OF THE INVENTION

### 1. Field of the Invention

The disclosures herein relate to image display control devices, image display systems and image display control methods.

### 2. Description of the Related Art

In recent years, in an image display control device, which is a device to display on a display device having a backlight in which a plurality of light sources are arranged in an array, local dimming to adjust luminance of respective light sources according to luminance of an input image has been known. The local dimming enables to reduce power consumption while improving a contrast ratio.

A backlight unit including a plurality of LED elements capable of independently controlling an amount of light emitted, and a plurality of optical sensors to detect the luminance of respective LED elements is known. In this type of backlight unit, when one of the optical sensors fails, another optical sensor is used instead of the failed optical sensor to estimate the luminance of the LED element corresponding to the failed optical sensor (e.g., see Patent Literature (PTL) 1).

If any of a plurality of light emitting regions included in a light source for illumination of a liquid crystal panel fails, a method for moving an image of a display region corresponding to the failed light emitting region to a display region corresponding to a normal light emitting region is known (e.g., see PTL 2).

For example, an image display control device that performs local dimming has a luminance control unit that adjusts the luminance of a plurality of light sources according to the luminance of an input image, and a pixel compensation unit that adjusts the luminance of an image according to an adjusted luminance of the light sources. If an abnormality occurs in the luminance control unit, the luminance or color of the image displayed on the display device may change.

For example, a part of the abnormality in the luminance control unit can be detected by a cyclic redundancy check (CRC) or the like that detects an abnormality in communication between the luminance control unit and a driver that drives the light sources. However, for example, if an image (video) is displayed in a state where each light source is not turned off but is still emitting light, it is difficult to confirm whether or not the luminance output value from the luminance control unit to the driver is normal. For example, an abnormality in the luminance output value can be determined by implementing identical circuits in parallel and comparing two outputs. However, in this case, a circuit size increases and a cost of the image display control device increases.

An object of the present invention is to detect the abnormality in the luminance control unit to control the luminance of the plurality of light sources mounted on the image display control device having a local dimming function.

### CITATION LIST

### Patent Literature

[PTL 1] Japanese Laid-Open Patent Publication No. 2014-182291
[PTL 2] Japanese Laid-Open Patent Publication No. 2018-159796

### SUMMARY OF THE INVENTION

According to an embodiment of the present invention, an image display control device having a local dimming function, includes a luminance control unit configured to generate backlight control information used for controlling a plurality of light sources included in a backlight based on first image information indicating an input image, a pixel compensation unit configured to generate second image information indicating an output image by correcting one or more pixel values included in the first image information based on luminance of the plurality of light sources, a first statistics acquisition unit configured to acquire first statistical data of the pixel values included in the first image information, a second statistics acquisition unit configured to acquire second statistical data of one or more luminance values included in the backlight control information, the luminance values corresponding to the light sources, and an abnormality detection unit configured to detect an abnormality of the luminance control unit according to whether or not the second statistical data is included in a range between an upper limit value and a lower limit value, the upper limit value and the lower limit value being determined by the first statistical data.

According to the disclosed technology, an abnormality in a luminance control unit to control luminance of a plurality of light sources mounted on an image display control device having a local dimming function can be detected.

### BRIEF DESCRIPTION OF THE DRAWINGS

FIG. 1 is a block diagram illustrating an example of an image display system according to a first embodiment;

FIG. 2 is a block diagram illustrating an example of a display controller of FIG. 1;

FIG. 3 is a block diagram illustrating an example of a local dimming unit of FIG. 2;

FIG. 4 is a drawing illustrating an example of controlling luminance of a backlight by a luminance control unit of FIG. 3;

FIG. 5 is a drawing illustrating an example of generating luminance distribution by a luminance distribution calculation unit of FIG. 3;

FIG. 6 is a drawing illustrating an example of correcting the luminance of an image by an RGB correction unit of FIG. 3;

FIG. 7 is a drawing illustrating an example of statistical information acquired by an input color statistics acquisition unit and an output luminance statistics acquisition unit of FIG. 3;

FIG. 8 is a drawing illustrating an example of a threshold used to determine an abnormality of the luminance control unit of FIG. 3;

FIG. 9 is a flowchart illustrating an example of a process to determine the abnormality of the luminance control unit by a processor of FIG. 3;

FIG. 10 is a flowchart illustrating an example of a process in step S80 of FIG. 9;

FIG. 11 is a block diagram illustrating an example of a display controller according to a second embodiment;

FIG. 12 is a block diagram illustrating an example of an input color statistics acquisition unit, an output luminance statistics acquisition unit, and an output color statistics acquisition unit connected to the local dimming unit of FIG. 11;

FIG. 13 is a drawing illustrating an example of statistical data acquired by the input color statistics acquisition unit, the output luminance statistics acquisition unit, and the output color statistics acquisition unit of FIG. 12;

FIG. 14 is a drawing illustrating an example of a threshold used to determine an abnormality of the luminance control unit of FIG. 12; and

FIG. 15 is a flowchart illustrating an example of a process to determine an abnormality of the luminance control unit by the processor of FIG. 12.

### DESCRIPTION OF THE PREFERRED EMBODIMENTS

In the following, embodiments of the present invention will be described with reference to the accompanying drawings. In the following description, image data may be referred to simply as an image.

### First Embodiment

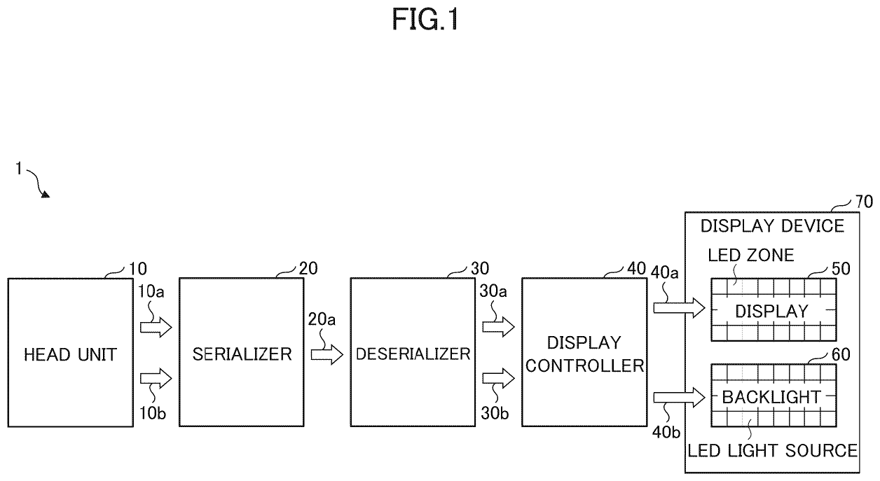

FIG. 1 is a block diagram illustrating an example of an image display system according to a first embodiment. The image display system 1 shown in FIG. 1 includes a head unit 10, a serializer 20, a deserializer 30, a display controller 40, and a display device 70 including a display 50 and a backlight 60.

The head unit 10 generates an image to be displayed on the display 50. The head unit 10 outputs image data 10a and control information 10b corresponding to the generated image to the serializer 20. For example, the control information 10b includes information used for control when displaying the image on the display 50. For example, the image data 10a may include a superimposed image such as an icon superimposed on an original image.

The serializer 20 converts the image data 10a and control information 10b output from the head unit 10 into serial data 20a. The serializer 20 transmits the serial data 20a acquired by the conversion to the deserializer 30 via one video link (transmission line). Although not specifically limited, transmission and reception of the serial data 20a via the video link is performed using an interface such as LVDS (Low Voltage Differential Signaling) or APIX (Automotive Pixel Link).

The deserializer 30 converts the serial data 20a received via the video link into image data 30a and control information 30b. The image data 30a and the control information 30b correspond to the original image data 10a and the control information 10b output by the head unit 10, respectively. The deserializer 30 outputs the image data 30a and the control information 30b acquired by the conversion to the display controller 40.

The display controller 40 outputs information 40a, including image data that specifies the image to be displayed on the display 50, based on the image data 30a and the control information 30b received from the deserializer 30. The display controller 40 also outputs information 40b that controls the luminance of the backlight 60 to the backlight 60, based on the image data 30a and the control information 30b. The display controller 40 is an example of an image display control device.

Although not specifically limited, the image data input to the display controller 40 and the image data output from the display controller 40 include pixel values of red (R) pixels, green (G) pixels, and blue (B) pixels representing RGB color space.

The display 50 is, for example, a liquid crystal display including a liquid crystal shutter to adjust transmittance of light emitted from the backlight 60 and a color filter to receive light transmitted through the liquid crystal shutter. The display 50 may be a display other than a liquid crystal display as long as the transmittance of light emitted from the backlight 60 can be adjusted. The display 50 is an example of a display unit.

The backlight 60 includes a plurality of LED (Light Emitting Diode) light sources arranged in a matrix, and is arranged to face a surface of the display 50 opposite the image display surface. Hereinafter, a light irradiation zone corresponding to each LED light source in the display 50 is referred to as an LED zone. In place of the plurality of LED light sources arranged in a matrix, the backlight 60 may include a plurality of other light sources with adjustable luminance.

For example, the image display system 1 may be mounted on a vehicle. In this case, the display device 70 may be used, for example, to display an instrument cluster on an instrument panel or a center information display (CID). Alternatively, the display device 70 may be used for a head-up display to project an image onto a windshield.

The image display system 1 mounted on the vehicle is designed to satisfy requirements of ASIL (Automotive Safety Integrity Level). The image display system 1 equipped with the backlight and having a local dimming function is not limited to an in-vehicle application, and may be used for other image display systems such as digital signage.

For example, the display controller 40 performs a local dimming process to adjust independently the luminance of a plurality of LED backlights in accordance with the luminance (e.g., pixel values) of the image displayed on the display 50. In the local dimming process, the display controller 40 performs compensation control for suppressing an increase in the luminance of a surrounding image due to light leaking around a position facing the lit LED backlight. The local dimming process can improve the reproducibility of black in an image displayed on the display 50 while suppressing the power consumption of the backlight 60.

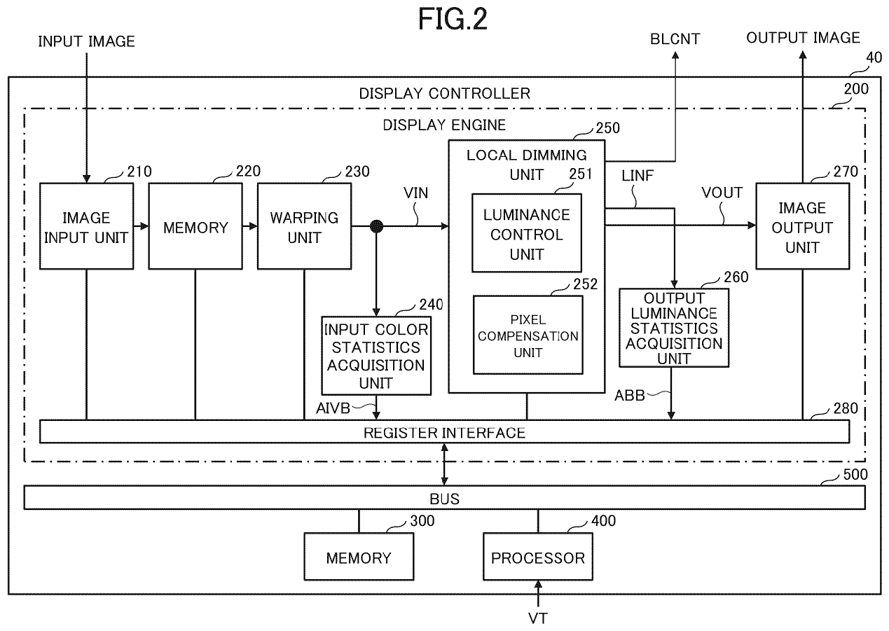

FIG. 2 is a block diagram illustrating an example of the display controller of FIG. 1. The display controller 40 is, for example, a semiconductor integrated circuit and includes a display engine 200, a memory 300, and a processor 400 interconnected via a bus 500.

The display engine 200 includes an image input unit 210, a memory 220, a warping unit 230, an input color statistics acquisition unit 240, a local dimming unit 250, an output luminance statistics acquisition unit 260, an image output unit 270, and a register interface 280. The local dimming unit 250 includes a luminance control unit 251 and a pixel compensation unit 252. For example, each element of the display engine 200 operates as controlled by the processor 400. Although not specifically limited, the display engine 200 processes image data representing an RGB color space.

The image input unit 210 receives image data (e.g., input images per frame) transmitted from the deserializer 30 shown in FIG. 1, and stores the received image data in the memory 220. The warping unit 230 uses the image data stored in the memory 220 to perform a distortion correction process to display a distortion-free image on the display 50 of FIG. 1. The warping unit 230 outputs the distortion-corrected input image data VIN to the local dimming unit 250.

The input color statistics acquisition unit 240 sequentially acquires the average input video luminance AIVB, which is the average of pixel values of one screen (one frame) included in the input image data VIN input from the warping unit 230 to the local dimming unit 250. For example, the input color statistics acquisition unit 240 acquires the average input video luminance AIVB by calculation. The average input video luminance AIVB is an example of first statistical data. The input image data VIN is an example of first image information, and the input color statistics acquisition unit 240 is an example of first statistical acquisition unit.

The input color statistics acquisition unit 240 outputs the acquired average input video luminance AIVB to the processor 400 via the register interface 280 and the bus 500. The input color statistics acquisition unit 240 may have a storage unit such as a buffer to store the average input video luminance AIVB. In this case, the average input video luminance AIVB stored in the storage unit may be read by the processor 400.

The display controller 40 has a local dimming function. That is, the luminance control unit 251 of the local dimming unit 250 generates a backlight control signal BLCNT to adjust the luminance of the backlight 60 shown in FIG. 1 based on the input image data VIN, and outputs the generated backlight control signal BLCNT to the backlight 60.

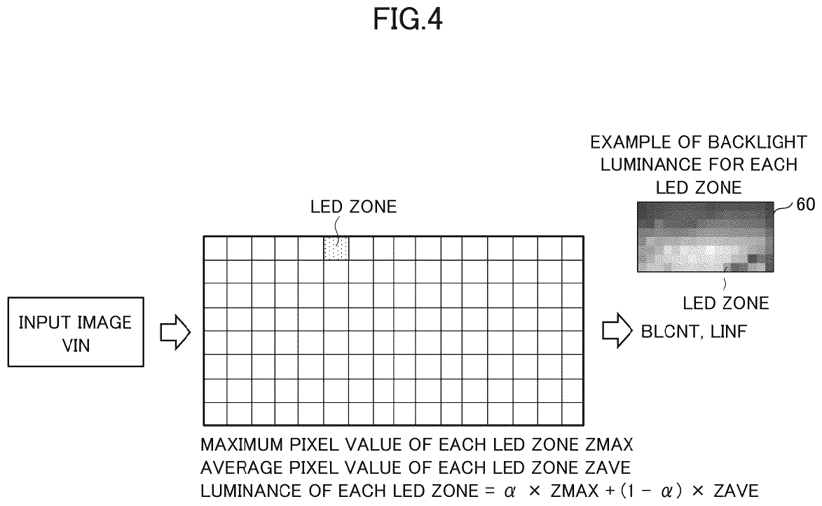

The luminance control unit 251 also outputs luminance information LINF indicating the luminance of each of the plurality of LED light sources of the backlight 60 to the output luminance statistics acquisition unit 260. For example, the luminance information LINF may include the same information as the information included in the backlight control signal BLCNT indicating the luminance of each of the plurality of LED light sources, or may be the backlight control signal BLCNT itself. A method of adjusting the luminance of the backlight 60 by the luminance control unit 251 will be described with reference to FIG. 4. The luminance information LINF and the backlight control signal BLCNT are examples of backlight control information.

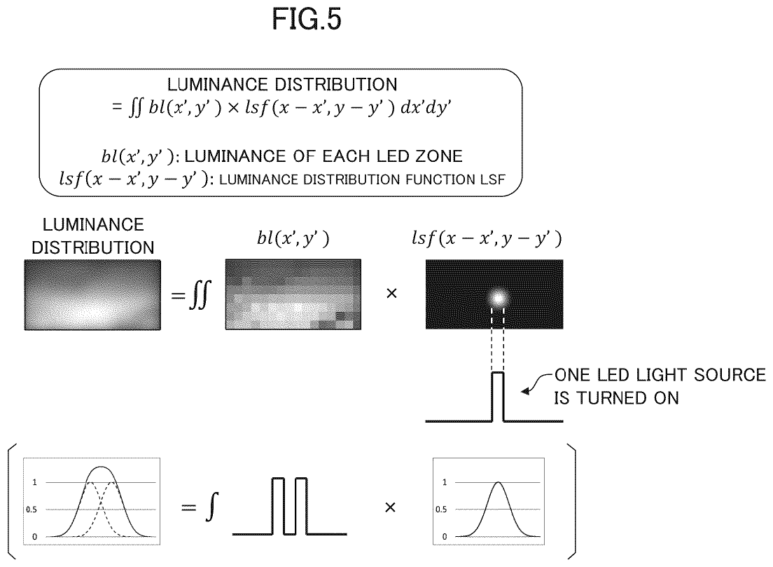

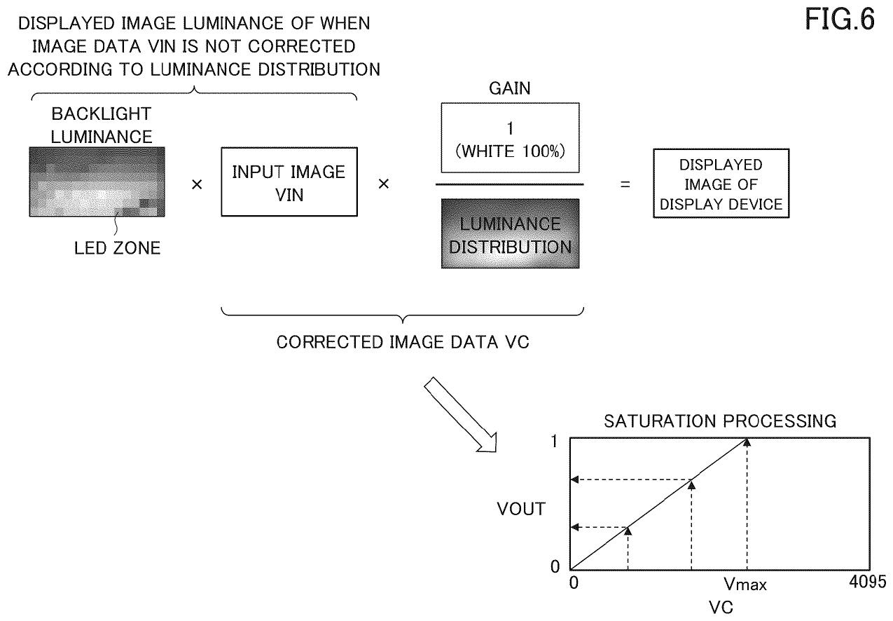

The pixel compensation unit 252 of the local dimming unit 250 corrects the pixel value (e.g., a luminance value) of the input image data VIN based on the luminance of the backlight 60 adjusted by the luminance control unit 251, and outputs the corrected pixel value to the image output unit 270 as the output image data VOUT. The output image data VOUT is an example of the second image information. For example, the pixel compensation unit 252 corrects the pixel value of the region where the luminance of the backlight 60 is high to relatively small, and corrects the pixel value of the region where the luminance of the backlight 60 is low to relatively large. At that time, the pixel compensation unit 252 corrects the pixel value in consideration of the leakage of light into the surroundings of each LED light source. An image correction method by the local dimming unit 250 is described in FIGS. 5 and 6.

The output luminance statistics acquisition unit 260 sequentially acquires luminance information LINF output from the local dimming unit 250 for each screen (or frame). The output luminance statistics acquisition unit 260 acquires average backlight luminance ABB, which is an average luminance of each LED light source included in the luminance information LINF. For example, the output luminance statistics acquisition unit 260 acquires average backlight luminance ABB by calculation. The average backlight luminance ABB is an example of second statistical data. The output color statistics acquisition unit 290 is an example of the second statistics acquisition unit.

The output luminance statistics acquisition unit 260 outputs the acquired average backlight luminance ABB to the processor 400 via the register interface 280 and the bus 500. The output luminance statistics acquisition unit 260 may have a storage unit such as a buffer to store the average backlight luminance ABB. In this case, the average backlight luminance stored in the storage unit may be read out by the processor 400.

The image output unit 270 transmits the output image data VOUT (e.g., an output image per frame) received from the local dimming unit 250 to the display 50 shown in FIG. 1, and causes the display 50 to display an image.

The memory 300 stores, for example, an image display control program executed by the processor 400 and data used in the image display control program. The processor 400 is a controller such as a CPU (Central Processing Unit) or a GPU (Graphics Processing Unit). For example, the processor 400 controls the operation of the display controller 40 by executing the image display control program.

The processor 400 detects the abnormality of the luminance control unit 251 based on the average input video luminance AIVB acquired by the input color statistics acquisition unit 240 and the average backlight luminance ABB acquired by the output luminance statistics acquisition unit 260 by executing the image display control program, for example. The functional unit to detect the abnormality of the luminance control unit 251 in the processor 400 is an example of an abnormality detection unit. The processor 400 can facilitate or hinder the detection of the abnormality based on threshold information received from outside the processor 400. The threshold information may be supplied from outside the image display system 1.

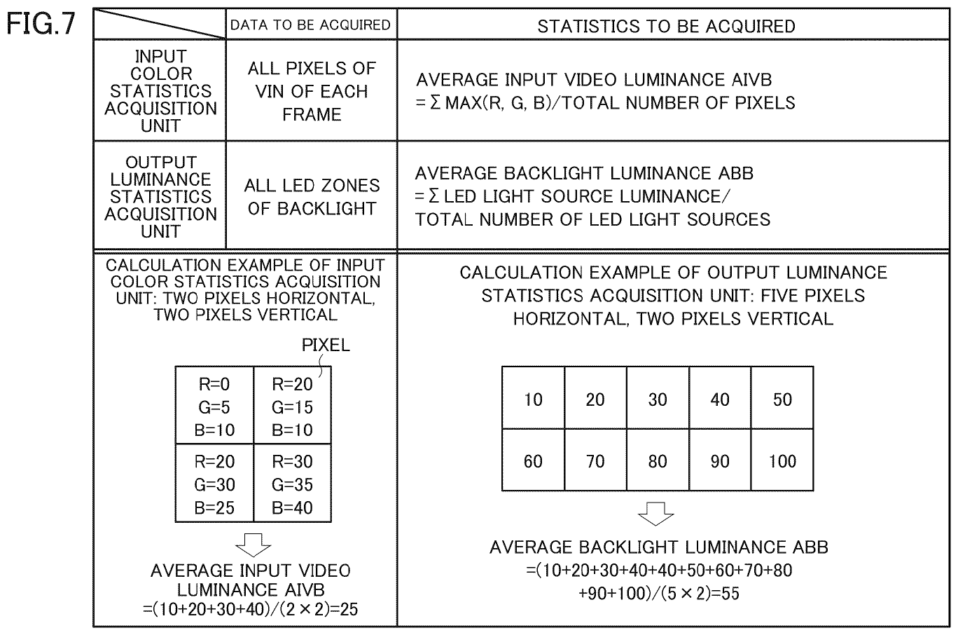

When the processor 400 has not acquired one or both of the average input video luminance AIVB from the input color statistics acquisition unit 240 and the average backlight luminance ABB from the output luminance statistics acquisition unit 260, the abnormality detection process of the luminance control unit 251 is prevented. The abnormality detection process of the luminance control unit 251 will be described with reference to FIGS. 7 to 10.

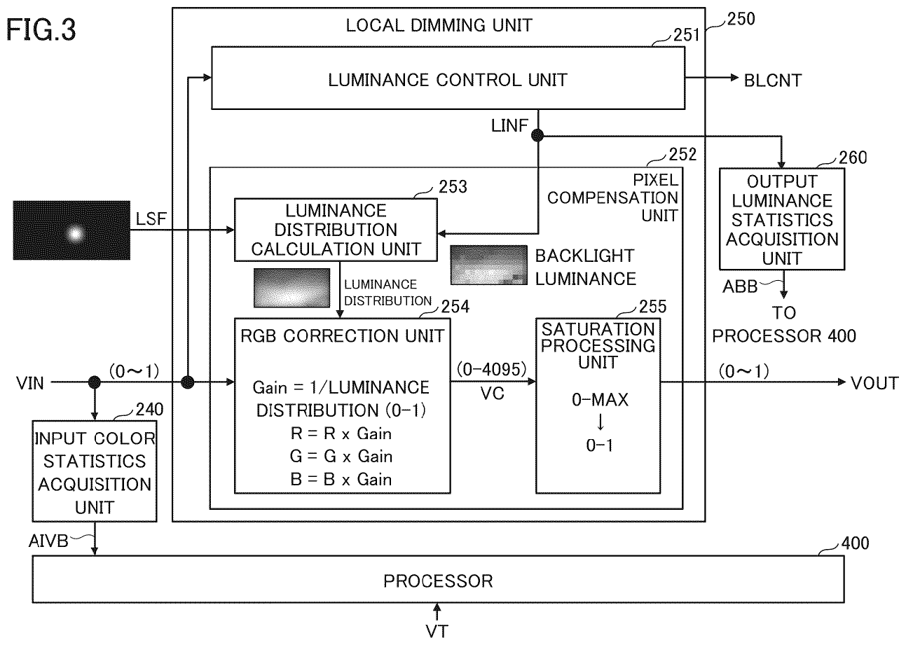

FIG. 3 is a block diagram illustrating an example of the local dimming unit 250 of FIG. 2. In FIG. 3, the register interface 280 and the bus 500 of FIG. 2 are omitted. The pixel compensation unit 252 of the local dimming unit 250 includes a luminance distribution calculation unit 253, an RGB correction unit 254, and a saturation processing unit 255.

The luminance distribution calculation unit 253 receives luminance information LINF indicating the luminance of each LED light source received from the luminance control unit 251, and LSF (Lighting Spread Function) which is a luminance distribution function when only one LED light source is lit up. Based on the luminance information LINF and the luminance distribution function LSF, the luminance distribution calculation unit 253 generates a luminance distribution of the backlight 60 in consideration of the leakage of light into the surroundings of each LED light source, and outputs information indicating the generated luminance distribution to the RGB correction unit 254. For example, the luminance distribution generated by the luminance distribution calculation unit 253 indicates the distribution of luminance values of the backlight 60 in each pixel of the display 50, and is indicated by a value greater than 0 and less than 1. The lower the luminance value of the luminance distribution, the closer to 0, and the higher the luminance value, the closer to 1.

Based on the luminance distribution (luminance value), the RGB correction unit calculates a gain of a pixel value to be applied to each pixel of the display 50 using formula (1). According to formula (1), the minimum value of the gain is one and the maximum value of the gain is infinity. Here, infinity is the maximum value that can be expressed by the number of bits representing the gain.

$$Gain = 1 / Luminance Distribution \qquad ( 1 )$$

The RGB correction unit 254 calculates a correction value of the pixel value of each color component by multiplying the pixel value of each color component of a corresponding pixel included in the input image data VIN by the gain calculated by formula (1) using formulae (2-1), (2-2), and (2-3). Symbol R in formula (2-1) refers to the pixel value of a red pixel. Symbol G in formula (3-2) refers to the pixel value of a green pixel. Symbol B in formula (2-3) refers to the pixel value of a blue pixel.

$$R = R \times Gain \qquad ( 2 - 1 )$$

$$G = G \times Gain \qquad ( 2 - 2 )$$

$$B = B \times Gain \qquad ( 2 - 3 )$$

For example, the pixel value of each color component of each pixel of the input image data VIN is normalized to be between 0 and 1. Therefore, when the image input unit 210 shown in FIG. 2 inputs eight bits of image data (0 to 255) for each pixel, the maximum value 255 corresponds to 1 for the input image data VIN. The RGB correction unit 254 outputs the corrected value of the calculated pixel value to the saturation processing unit 255 as the image data VC.

For example, each pixel value of the image data VC is expressed by twelve bits, and the minimum value is 0 and the maximum value is 4095. Note that each pixel value of the image data VC may be expressed by a number of bits other than twelve bits (e.g., ten bits or fourteen bits, etc.). When each pixel value of the input image data VIN is expressed by eight bits (0 to 255), each pixel value of the image data VC may be expressed by twenty bits (0 to 1048576).

The saturation processing unit 255 generates output image data VOUT by setting the highest pixel value of the image data VC to 1 and normalizing the other pixel values to 0 or more and less than 1. The saturation processing unit 255 outputs the generated output image data VOUT to the display 50.

FIG. 4 is a drawing illustrating an example of controlling the luminance of the backlight 60 by the luminance control unit 251 of FIG. 3. For example, the luminance control unit 251 finds the maximum value ZMAX of the pixel values and the average value ZAVE of the pixel values for each area corresponding to the LED zone of the backlight 60 in the input image data VIN corresponding to the input image. Here, the maximum value ZMAX and the average value ZAVE are found from the pixel values of the red pixel, the green pixel, and the blue pixel corresponding to each LED zone, and the maximum value is “1” and the minimum value is “0”.

Then, the luminance control unit 251 calculates the luminance of each LED zone using formula (3), outputs the backlight control signal BLCNT indicating the luminance found by the calculation to the backlight 60, and outputs the luminance information LINF to the pixel compensation unit 252 and the output luminance statistics acquisition unit 260. In formula (3), symbol α is a parameter for adjusting the luminance, and is set, for example, from 0 to 1. For example, when the luminance adjustment parameter α is 0.5, the maximum value ZMAX and the average value ZAVE are mixed by 50%. For example, the luminance adjustment parameter α may be set by a user using the image display system 1 or may be set externally.

$$Luminance of each LED zone = α \times Z MAX + ( 1 - α ) \times ZAVE \qquad ( 3 )$$

FIG. 5 is a drawing illustrating an example of generating luminance distribution by the luminance distribution calculation unit 253 of FIG. 3. Since the light emitted from each LED light source spreads to the adjacent LED zone, the luminance distribution is found in consideration of the spread (blurring) of the light. The luminance distribution calculation unit 253 finds the luminance distribution by convolution and integration of the luminance information LINF for each LED zone of the backlight 60 and the luminance distribution function LSF.

In the formula shown in FIG. 5, symbol x refers to a coordinate in the horizontal direction identifying the LED zone, and symbol y refers to a coordinate in the vertical direction referring to the LED zone. bl(x′, y′) distinguishes the luminance of each LED zone, and lsf(x-x′, y-y′) refers to the luminance distribution function LSF. The square brackets in FIG. 5 show an image of finding the luminance distribution by convolution and integration when two LED light sources are turned on and the other LED light sources are turned off.

FIG. 6 is a drawing illustrating an example of correcting the luminance of the image by the RGB correction unit 254 of FIG. 3. When the input image data VIN is output as the output image data VOUT without being corrected according to the luminance distribution, the luminance of the image displayed on the display 50 is a product of the luminance of the input image and the luminance of the backlight; therefore, an image with the correct luminance is not displayed.

For this reason, the RGB correction unit 254 calculates the gain for each pixel (for each RGB component) of the input image data VIN using formula (1), and corrects the pixel value by multiplying the calculated gain by the pixel value of the input image data VIN, thereby canceling the luminance of the backlight 60. As a result, the luminance of the image displayed on the display 50 can be correctly set using the light from the backlight 60 in which the luminance of the LED light source is individually adjusted according to the luminance of the image.

In the pixel value saturation process by the saturation processing unit 255 in FIG. 3, the maximum value Vmax of all the pixel values included in the image data VC is set to 1 of the pixel value of the output image data VOUT.

FIG. 7 is a drawing illustrating an example of statistical information acquired by an input color statistics acquisition unit 240 and an output luminance statistics acquisition unit 260 of FIG. 3.

The input color statistics acquisition unit 240 finds the maximum value MAX (the maximum value among the pixel value of a red pixel, the pixel value of a green pixel, and the pixel value of a blue pixel) of pixel values for each pixel in all pixels of the input image data VIN of each frame. The input color statistics acquisition unit 240 finds the average input video luminance AIVB by dividing the total of the maximum values MAX of all pixels by the total number of pixels. FIG. 7 shows a calculation example of the input color statistics acquisition unit 240 when the number of pixels is “four” (two pixels horizontal, two pixels vertical).

The output luminance statistics acquisition unit 260 acquires the luminance (set luminance) of each LED light source of the backlight 60 based on the luminance information LINF received from the luminance control unit 251. The output luminance statistics acquisition unit 260 acquires the average backlight luminance ABB by dividing the acquired total luminance of each LED light source by the total number of LED light sources. FIG. 7 shows a calculation example of the output luminance statistics acquisition unit 260 when the number of LED light sources is ten (five horizontally, two vertically).

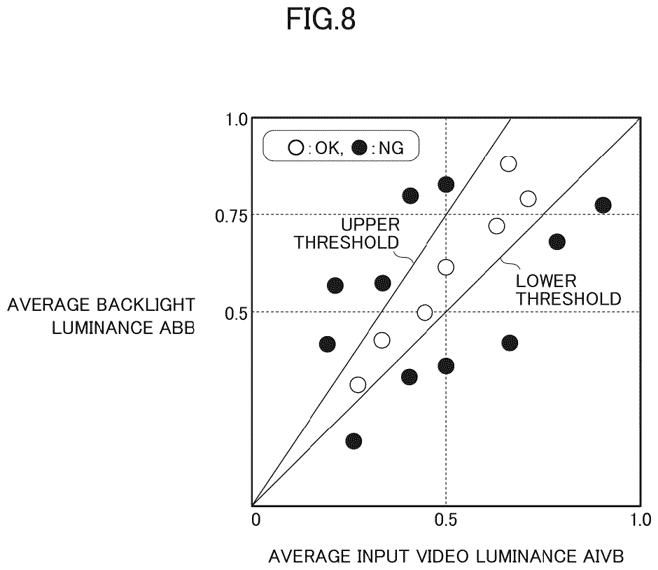

FIG. 8 is a drawing illustrating an example of a threshold used to determine an abnormality of the luminance control unit 251 of FIG. 3. The processor 400 determines whether there is no abnormality in the luminance of the backlight 60 for each input image data VIN of one frame. For example, the processor 400 finds an upper threshold and a lower threshold, which are the luminance ranges of the normal backlight 60, based on the average input video luminance AIVB of the frame to be determined acquired by the input color statistics acquisition unit 240. The upper threshold is an example of an upper limit value, and the lower threshold is an example of a lower limit value.

For example, when the pixel value of at least one pixel in the pixel region corresponding to the LED zone that is the irradiation zone of one LED light source is “1” (i.e., white), the maximum value ZMAX of formula (3) is “1”. In formula (3), when the maximum value ZMAX is “1” and the luminance adjustment parameter α is greater than “0”, the luminance of the LED zone found according to formula (3) is higher than the average value ZAVE of the pixel values in the pixel region corresponding to the LED zone, and reaches the upper limit. Therefore, applying this condition (ZMAX=“1”) to formula (3), the average input video luminance AIVB is used instead of the average value ZAVE of the pixel values corresponding to the LED zone of formula (3), and the upper threshold is found according to formula (4).

$$Upper threshold = α + ( 1 - α ) \times AIVB \qquad ( 4 )$$

The luminance of each LED zone shown in formula (3) is the average value ZAVE when the luminance adjustment parameter α is “0”. Therefore, the condition (α=“0”) is applied to formula (3), the average input video luminance AIVB is used instead of the average value ZAVE of the pixel values corresponding to the LED zone in formula (3), and the lower threshold is found by formula (5).

$$Lower Threshold = AIVB \qquad ( 5 )$$

For example, when α=“0.5” and the average input video luminance of the judgment target frame AIVB=“0.5”, the upper threshold is “0.75” according to formula (4), and the lower threshold is “0.5” according to formula (5).

Then, when the average backlight luminance ABB is not in the range sandwiched between the upper threshold and the lower threshold in the average input video luminance AIVB of the judgment target frame, the processor 400 judges that the luminance control unit 251 is abnormal (black circle: NG). For example, the abnormality of the luminance control unit 251 occurs due to an abnormality in the generation process of the luminance information LINF and the backlight control signal BLCNT. Conversely, when the average backlight luminance ABB of the average input video luminance AIVB of the judgment target frame is in the range sandwiched between the upper threshold and the lower threshold, the processor 400 judges that the luminance control unit 251 is normal (white circle: OK).

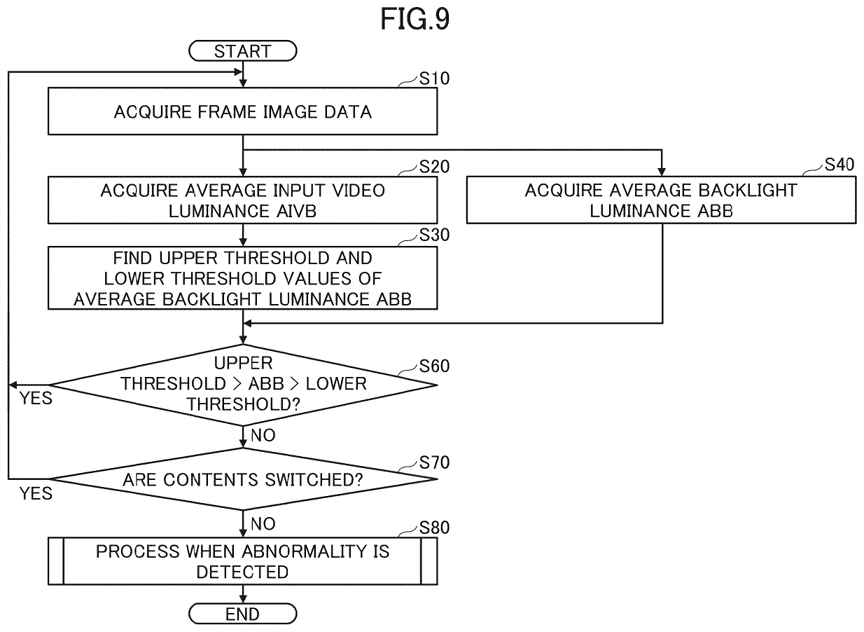

FIG. 9 is a flowchart illustrating an example of a process to determine the abnormality of the luminance control unit 251 by the processor 400 of FIG. 3. That is, FIG. 9 shows an example of an image display control method by the processor 400 and an image display control program executed by the processor 400. The flow shown in FIG. 9 starts, for example, when the image display system 1 is started or the display controller 40 is started. It should be noted that the processes of steps S10 to S70 are performed for each frame.

First, in step S10, the processor 400 causes the image input unit 210 to acquire frame image data. Next, in step S20, the processor 400 causes the input color statistics acquisition unit 240 to acquire the average input video luminance AIVB of the input image data VIN.

Next, in step S30, the processor 400 finds the upper threshold and lower threshold values of the average backlight luminance ABB based on the average input video luminance AIVB acquired in step S20. After step S10, in step S40, the processor 400 causes the output luminance statistics acquisition unit 260 to acquire the average backlight luminance ABB.

After steps S30 and S40, in step S60, the processor 400 determines whether or not the average backlight luminance ABB acquired in step S40 is within the range of the upper threshold and lower threshold found in step S30. If the average backlight luminance ABB is within the range of the upper threshold and lower threshold, the processor 400 determines that the luminance control unit 251 is normal, and returns the process to step S10. If the average backlight luminance ABB is not within the range of the upper threshold and lower threshold, the processor 400 determines that the luminance control unit 251 is abnormal, and shifts the process to step S70.

In step S70, the processor 400 determines whether or not the contents of the image displayed on the display 50 have been switched. When the contents have been switched, the processor 400 determines that a deviation of either the average input video luminance AIVB or the average backlight luminance ABB, or of both has increased due to the switching of the contents, and that the abnormality of the luminance control unit 251 has been determined.

The processor 400 then returns the process to step S10. That is, if the contents of the image have been switched, the processor 400 prevents the abnormality detection process of the luminance control unit 251 even if the average backlight luminance ABB is not within the upper threshold and lower threshold ranges. If the contents have not been switched, the processor 400 determines that the abnormality has occurred in the luminance control unit 251, and the process proceeds to step S80.

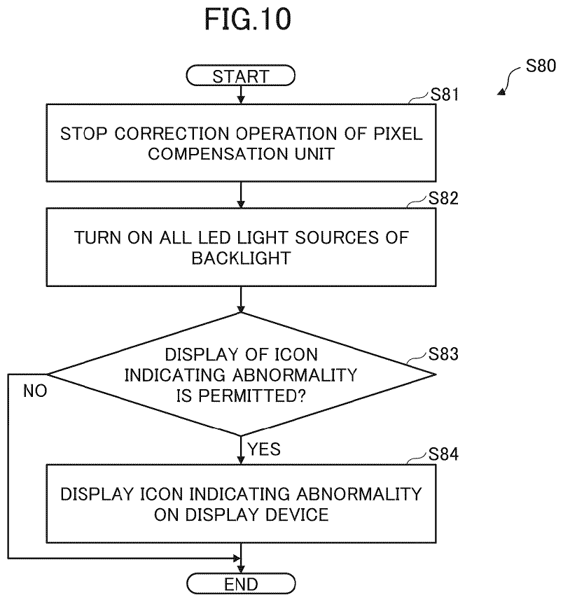

In step S80, the processor 400 performs the process when the abnormality of the luminance control unit 251 is detected, and ends the process shown in FIG. 9. An example of step S80 is shown in FIG. 10.

When the processor 400 determines that the contents are switched in step S70, it may return the process to step S10 by assuming that the luminance control unit 251 is normal without determining the abnormality in step S60 for a duration of at least one frame.

The processor 400 may also prevent the detection process of the abnormality of the luminance control unit 251 by step S60 for a duration of at least one frame when the image display system 1 or the display controller 40 is started. The processor 400 may return the process to step S10 by assuming that the luminance control unit 251 is normal without determination in step S60. Thus, it is possible to prevent the erroneous detection of the abnormality of the luminance control unit 251 due to video disturbance or the like when the contents are switched or the device is started.

FIG. 10 is a flowchart illustrating an example of a process in step S80 of FIG. 9. First, in step S81, the processor 400 stops the pixel value correction operation performed by the pixel compensation unit 252. Then, the processor 400 causes the pixel compensation unit 252 to be bypassed and the input image data VIN to be output to the display 50 as the output image data VOUT. Thus, when the luminance information LINF is not normal due to an abnormality in the luminance control unit 251 and the luminance distribution calculation unit 253 cannot generate a normal luminance distribution, it is possible to prevent the RGB correction unit 254 from generating the image data VC using incorrect luminance distribution.

Next, in step S82, the processor 400 stops the dimming operation performed by the local dimming unit 250, causes all the LED light sources of the backlight 60 to be turned on, and sets the backlight 60 to the preset luminance (e.g., maximum luminance). That is, the processor 400 causes all the LED light sources to be turned on at the predetermined luminance regardless of the operation of the luminance control unit 251. Thus, when the abnormality in the luminance control unit 251 is a decrease in luminance, it is possible to display an image on the display 50 without a decrease in luminance.

Next, in step S83, the processor 400 determines whether the display of an icon indicating the abnormality in the luminance control unit 251 is permitted. If the display of an icon indicating an abnormality is permitted, the processor 400 proceeds to step S84. If the display of an icon indicating an abnormality is not permitted, the processor 400 ends the process shown in FIG. 10.

In step S84, the processor 400 causes the display 50 to display an icon indicating an abnormality, and ends the process shown in FIG. 10. In step S84, the processor 400 may directly control the display 50 and use the OSD (On Screen Display) function of the display 50 to display an icon indicating an abnormality. The processor 400 may also cause the display 50 to display an icon indicating an abnormality by inputting image data indicating an icon to the image input unit 210 or by overwriting the icon data to an area storing image data in the memory 220.

As described above, in the present embodiment, it is possible to detect an abnormality of the luminance control unit 251 that cannot be detected conventionally based on the input image data VIN input to the pixel compensation unit 252 and the luminance information LINF output from the luminance control unit 251.

The processor 400 finds an upper threshold and a lower threshold of the average backlight luminance ABB to determine an abnormality of the luminance control unit 251 based on the average input video luminance AIVB of the input image data VIN input to the local dimming unit 250. Thus, the upper threshold value and the lower threshold value for detecting the abnormality of the luminance control unit 251 can be appropriately set in accordance with the characteristics of the image represented by the input image data VIN for each frame. As a result, the determination accuracy of the abnormality of the luminance control unit 251 can be improved.

The processor 400 does not detect the abnormality of the luminance control unit 251 for a duration of at least one frame when the contents are switched, or the display controller 40 or the like is started. Thus, it is possible to prevent the erroneous detection of the abnormality of the luminance control unit 251 due to video disturbance or the like when the contents are switched or the device is started.

When the abnormality of the luminance control unit 251 is detected, the processor 400 stops the pixel value correction operation by the pixel compensation unit 252. Thus, when the luminance information LINF is not normal due to the abnormality of the luminance control unit 251 and the luminance distribution calculation unit 253 cannot generate a normal luminance distribution, it is possible to prevent the RGB correction unit 254 from generating image data VC using an erroneous luminance distribution.

When the abnormality of the luminance control unit 251 is detected, by turning on all the LED light sources of the backlight 60, when the abnormality of the luminance control unit 251 is a decrease in luminance, it is possible to display an image on the display 50 without reducing luminance. When an abnormality of the luminance control unit 251 is detected, an icon indicating the abnormality can be displayed on the display 50 to notify the user or the like of the abnormality of the luminance control unit 251. In practice, the icon indicating the abnormality is one or both of a graphic and a character by which the user or the like can recognize the abnormality of the display controller 40.

Furthermore, even when a normal local dimming process is not performed due to the occurrence of the abnormality of the luminance control unit 251 and the contrast of the image displayed on the display device 70 is low, the abnormality of the luminance control unit 251 can be detected and the LED light source of the backlight 60 can be fully turned on. As a result, the contrast of the image displayed on the display device 70 can be increased, thereby satisfying the requirement of the ASIL.

### Second Embodiment

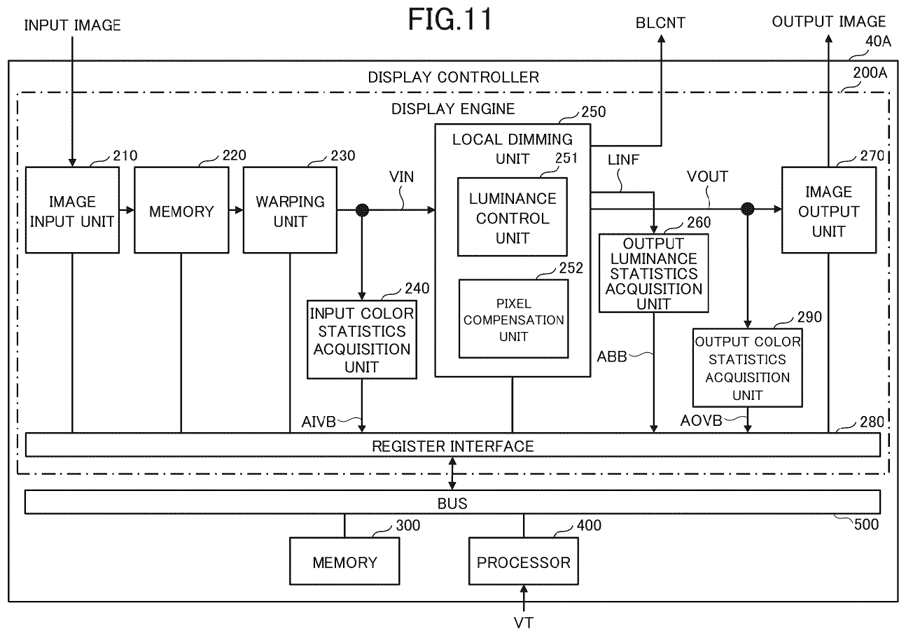

FIG. 11 is a block diagram illustrating an example of a display controller according to a second embodiment. Elements corresponding to those in FIG. 2 are denoted by the same reference numerals, and a detailed description thereof will be omitted. The display controller 40A shown in FIG. 11 is mounted instead of the display controller 40 in the image display system 1 shown in FIG. 1, for example.

The display controller 40A has a display engine 200A instead of the display engine 200 of FIG. 2. The display engine 200A has the same configuration as the display engine 200 of FIG. 2 except that an output color statistics acquisition unit 290 is added to the display engine 200 of FIG. 2.

The output color statistics acquisition unit 290 sequentially acquires the average output image luminance AOVB, which is the average of pixel values of one screen (one frame) included in the output image data VOUT output from the local dimming unit 250 to the image output unit 270. For example, the output color statistics acquisition unit 290 acquires the average output image luminance AOVB by calculation.

In the present embodiment, the average input video luminance AIVB is an example of the first statistical data. The input color statistics acquisition unit 240 is an example of the first statistical data acquisition unit. The average output image luminance AOVB is an example of the second statistical data. The output color statistics acquisition unit 290 is an example of the second statistics acquisition unit. The average backlight luminance ABB is an example of the third statistics data. The output luminance statistics acquisition unit 260 is an example of the third statistics acquisition unit.

The output color statistics acquisition unit 290 outputs the acquired average output image luminance AOVB to the processor 400 via the register interface 280 and the bus 500. The output color statistics acquisition unit 290 may have a storage unit such as a buffer to store the average output image luminance AOVB. In this case, the average output image luminance AOVB stored in the storage unit may be read out by the processor 400.

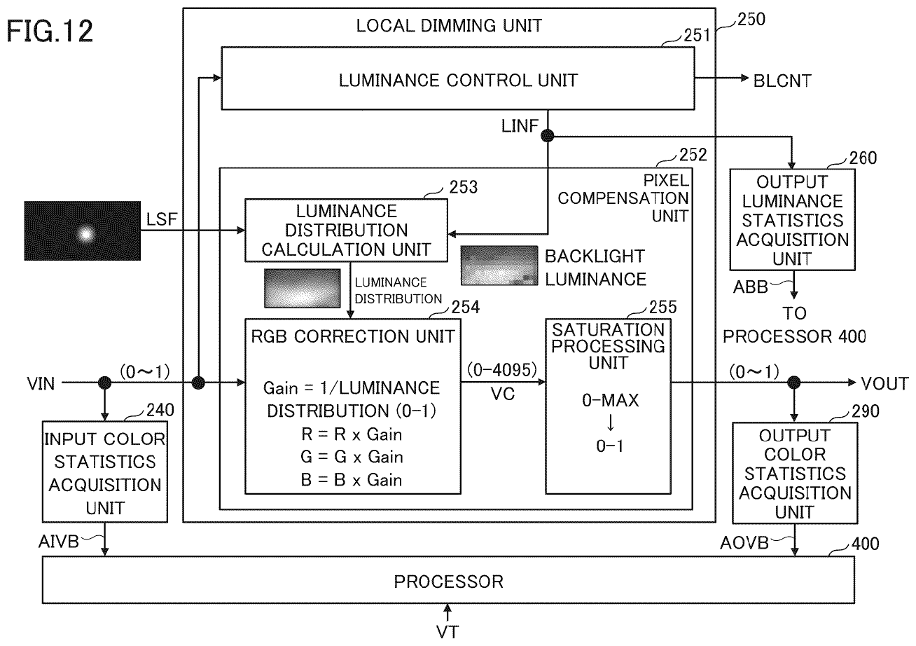

FIG. 12 is a block diagram illustrating an example of the input color statistics acquisition unit 240, the output luminance statistics acquisition unit 260, and the output color statistics acquisition unit 290 connected to the local dimming unit 250 of FIG. 11. In FIG. 12, the register interface 280 and the bus 500 of FIG. 2 are omitted. The configuration of the local dimming unit 250, the input color statistics acquisition unit 240, and the output luminance statistics acquisition unit 260 and the connection relation of the respective elements are same as those in FIG. 3 except that the output color statistics acquisition unit 290 is added.

The input color statistics acquisition unit 240 acquires the average input video luminance AIVB, which is statistical data of the input image data VIN normalized from 0 to 1. The output color statistics acquisition unit 290 acquires the average output image luminance AOVB, which is statistical data of the output image data VOUT normalized from 0 to 1. Thus, the processor 400 can calculate the upper threshold and lower threshold values described later without matching the scales (number of bits, etc.) of the average input video luminance AIVB and the average output image luminance AOVB to each other.

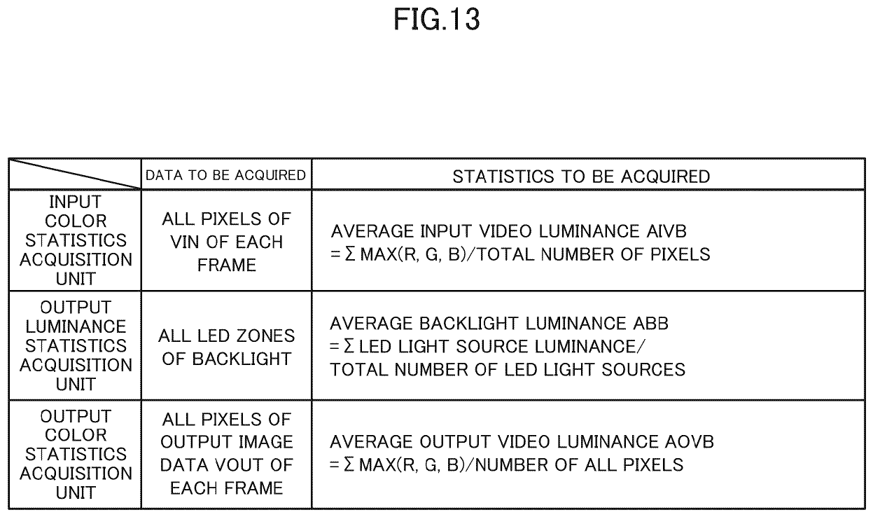

FIG. 13 is a drawing illustrating an example of statistical data acquired by the input color statistics acquisition unit 240, the output luminance statistics acquisition unit 260, and the output color statistics acquisition unit 290 of FIG. 12. The statistical data (average input video luminance AIVB and average backlight luminance ABB) acquired by the input color statistics acquisition unit 240 and the output luminance statistics acquisition unit 260 are same as those in FIG. 7.

The output color statistics acquisition unit 290 finds the maximum value MAX (maximum value among the pixel value of a red pixel, the pixel value of a green pixel, and the pixel value of a blue pixel) of pixel values for each pixel in all pixels of the output image data VOUT of each frame. Then, the output color statistics acquisition unit 290 finds the average output video luminance AOVB by dividing the total of the maximum values MAX of all pixels by the number of all pixels.

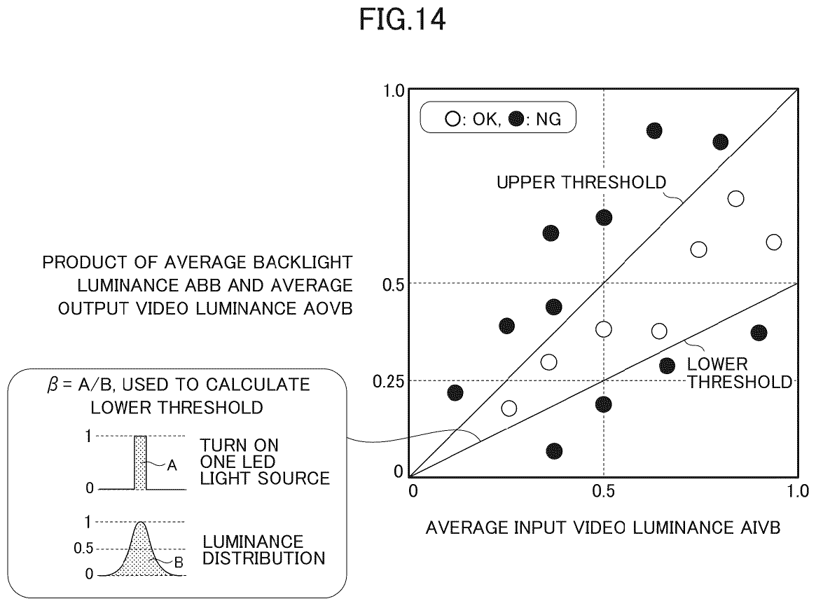

FIG. 14 is a drawing illustrating an example of a threshold used to determine the abnormality of the luminance control unit 251 of FIG. 12. The processor 400 determines whether there is any abnormality in the luminance of the backlight 60 for each input image data VIN of one frame.

As described in FIG. 6, in the correction of the luminance of the image by the RGB correction unit 254, the luminance of the backlight 60 is canceled as shown in formula (6) by dividing the input image data VIN by the luminance (luminance distribution) of the backlight 60. Formula (7) is derived by moving “backlight luminance” on the left side of formula (6) to the right side.

$$Input Image Data VIN / Backlight Luminance = Output Image Data VOUT \qquad ( 6 )$$

$$Input Image Data VIN = Backlight Luminance \times Output Image Data VOUT \qquad ( 7 )$$

For example, in Formula (7), “input image data VIN” can be approximated to “average input video luminance AIVB” acquired by input color statistics acquisition unit 240. “Output image data VOUT” can be approximated to “average output image luminance AOVB” acquired by the output color statistics acquisition unit 290. “Backlight luminance” can be approximated to “average backlight luminance ABB” acquired by the output luminance statistics acquisition unit 260. Formula (8) is derived by replacing formula (7) with the respective approximated terms. That is, “average backlight luminance ABB×average output image luminance AOVB” has a value corresponding to (approximating) “average input video luminance AIVB”.

$$Average input video luminance AIVB \approx Average Backlight Luminance ABB \times Average Output Image Luminance AOVB \qquad ( 8 )$$

In the present embodiment, when “average backlight luminance ABB×average output image luminance AOVB” in “average input video luminance AIVB” acquired by the input color statistics acquisition unit 240 does not fall within a predetermined range, the processor 400 determines an abnormality of the luminance control unit 251. The predetermined range is indicated by an upper threshold value and a lower threshold value. “Average backlight luminance ABB×average output image luminance AOVB” is an example of output statistical data. The upper threshold value is an example of an upper limit value, and the lower threshold value is an example of a lower limit value.

Here, as described with reference to FIG. 5, the luminance distribution of the backlight 60 is determined in consideration of light bleeding into adjacent LED zones. The actual luminance of each LED zone of the backlight 60 is higher than the set luminance set for each LED light source by adding the amount of bleeding from adjacent LED zones. That is, “average backlight luminance ABB” is smaller than the average value of the actual luminance of the LED zone of the backlight 60 because the amount of bleeding from adjacent LED zones is not considered.

Therefore, “average backlight luminance ABB×average output video luminance AOVB” in formula (8) does not exceed the product of the actual luminance of the backlight 60 and the output image data VOUT output from the pixel compensation unit 252, and the upper threshold of “average backlight luminance ABB×average output video luminance AOVB” in formula (8) does not exceed the average input video luminance AIVB. Therefore, “average input video luminance AIVB” itself is set to the upper threshold (formula (9)).

$$Upper Threshold = Average Input Video Luminance AIVB \qquad ( 9 )$$

Since the “average backlight luminance ABB×average output video luminance AOVB” is smaller than the average value of the actual luminance of the LED zones of the backlight 60, the lower threshold of “average backlight luminance ABB” must be set in consideration of the bleed from the adjacent LED zones. For this reason, the lower threshold is set to a value found by multiplying the “average input video luminance AIVB” by the luminance adjustment parameter β(0<β<1) (formula (10)). The luminance adjustment parameter β is an example of a coefficient to be multiplied by the average input video luminance AIVB. For example, the luminance adjustment parameter β is set to the ratio A/B between the area A and the area B shown in FIG. 14. The area A is an integrated value of the luminance without considering light bleeding when one LED light source is turned on. The area B is an integrated value of the luminance of the luminance distribution shown in FIG. 5 with light bleeding considered.

$$Lower Threshold = Average Input Video Luminance AIVB \times β \qquad ( 10 )$$

The “average input video luminance AIVB” in formula (9) and the “average input video luminance AIVB×β” in formula (10) are examples of input statistical data. When the “average backlight luminance ABB×average output video luminance AOVB” of the frame to be determined is not within the range sandwiched between the upper threshold and the lower threshold shown in formulae (9) and (10), the processor 400 determines an of abnormality the luminance control unit 251 (black circle: NG). When the “average backlight luminance ABB×average output video luminance AOVB” of the frame to be determined is included in the range sandwiched between the upper threshold and the lower threshold shown in formulae (9) and (10), the processor 400 determines that the luminance control unit 251 is normal (white circle: OK).

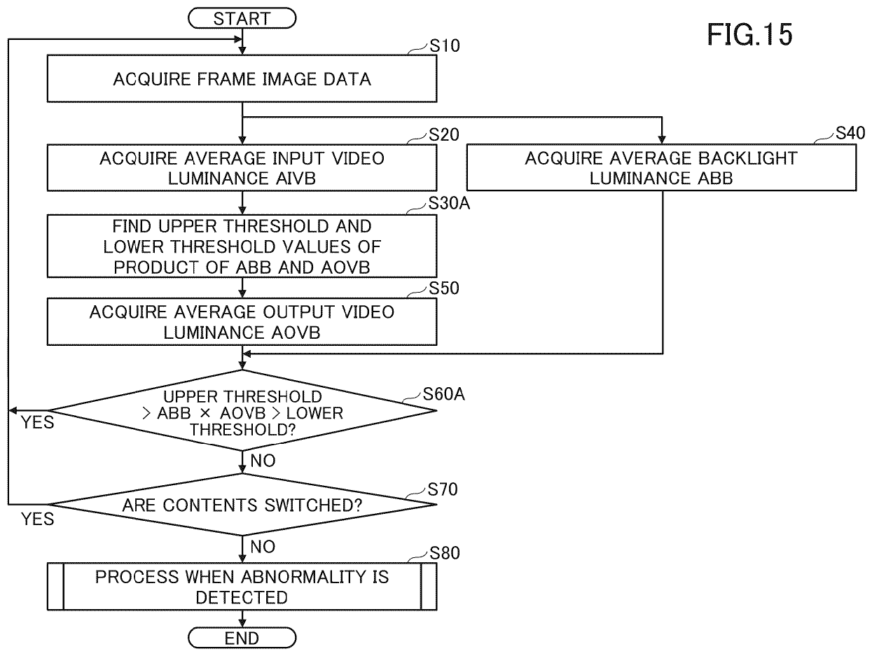

FIG. 15 is a flowchart illustrating an example of a process to determine an abnormality of the luminance control unit 251 by the processor 400 of FIG. 12. That is, FIG. 15 shows an example of the image display control method by the processor 400 and the image display control program executed by the processor 400. A detailed description of the process corresponding to that shown in FIG. 9 is omitted. The flow shown in FIG. 15 starts, for example, when the image display system 1 is started or the display controller 40 is started. It should be noted that the processes from steps S10 to S70 are performed for each frame.

In the flowchart shown in FIG. 15, steps S30A and S60A are performed instead of steps S30 and S60 in FIG. 9. Further, step S50 is added between step S30A and step S60A. The other processes in FIG. 15 are same as those in FIG. 9. The processes in step S80 are same as those in FIG. 10.

In step S30A, the processor 400 finds an upper threshold value and a lower threshold value corresponding to the product of the average backlight luminance ABB and the average output image luminance AOVB based on the average input video luminance AIVB acquired in step S20 and the preliminarily found luminance adjustment parameter β. Next, in step S50, the processor 400 causes the output color statistics acquisition unit 290 to acquire the average output image luminance AOVB of the output image data VOUT. Step S50 may be performed in parallel with steps S20 and S40.

After steps S40 and S50, in step S60A, the processor 400 finds the product “ABB×AOVB” of the average backlight luminance ABB and the average output image luminance AOVB acquired in steps S40 and S50. Then, the processor 400 determines whether or not the found product “ABB×AOVB” is within the range of the upper threshold and lower threshold values found in step S30A.

When the product “ABB×AOVB” is within the range of the upper threshold and lower threshold, the processor 400 determines that the luminance control unit 251 is normal, and returns the process to step S10. When the product “ABB×AOVB” is not within the range of the upper threshold and lower threshold, the processor 400 determines that the luminance control unit 251 is abnormal, and returns the process to step S70. The processes of steps S70 and S80 are same as those of steps S70 and S80 in FIG. 9.

As described above, the same effects as those of the above-described embodiment can be acquired in the present embodiment. For example, based on the input image data VIN input to the pixel compensation unit 252, the output image data VOUT output from the pixel compensation unit 252, and the luminance information LINF output from the luminance control unit 251, it is possible to detect abnormalities of the luminance control unit 251 that could not be detected conventionally.

Furthermore, in the present embodiment, the processor 400 can determine the upper threshold value and the lower threshold value without using the luminance adjustment parameter α. Thus, it is possible to prevent the upper threshold value and the lower threshold value from changing depending on the luminance adjustment parameter α set by the user or the like. As a result, for example, it is possible to prevent the normal range of the luminance of the backlight 60 set by the upper threshold value and the lower threshold value from widening depending on the luminance adjustment parameter α, and it is possible to prevent the detection accuracy of abnormalities of the luminance control unit 251 from deteriorating.

Incidentally, in the first and second embodiments described above, an example of calculating the upper and lower threshold values in step S30 of FIG. 9 or step S30A of FIG. 15 based on the pixel values of the input image data VIN input to the local dimming unit 250 has been described. However, when the image to be displayed on the display device 70 is determined, the upper and lower threshold values may be found from the pixel values previously acquired corresponding to the image to be displayed. In this case, the upper and lower threshold values corresponding to the image to be displayed are stored in the memory 300 and referred to by the processor 400. In this case, the process of calculating the upper and lower threshold values in step S30 of FIG. 9 and step S30A of FIG. 15 is omitted.

In the first and second embodiments described above, the upper and lower threshold values are found based on all the pixel values of the input image data VIN input by the local dimming unit 250, and the abnormality of the luminance control unit 251 is detected based on the found upper and lower threshold values. However, instead of all the pixel values included in the input image data VIN, the upper and lower threshold values may be found based on the pixel values of pixels having a smaller number of images acquired by thinning out a part of the pixels included in the input image data VIN. In this case, the calculation load of the input color statistics acquisition unit 240 and the output color statistics acquisition unit 290 can be reduced, and the calculation load of the upper and lower threshold values by the processor 400 can be reduced. As a result, an increase in the power consumption of the display controllers 40 and 40A can be suppressed.

Further, the present invention is not limited to these embodiments, but various variations and modifications may be made without departing from the scope of the present invention.

What is claimed is:

1. An image display control device having a local dimming function, comprising:
a luminance control unit configured to generate backlight control information used for controlling a plurality of light sources included in a backlight based on first image information indicating an input image;
a pixel compensation unit configured to generate second image information indicating an output image by correcting one or more pixel values included in the first image information based on luminance of the plurality of light sources;
a first statistics acquisition unit configured to acquire first statistical data of the pixel values included in the first image information;
a second statistics acquisition unit configured to acquire second statistical data of one or more luminance values included in the backlight control information, the luminance values corresponding to the light sources; and
an abnormality detection unit configured to detect an abnormality of the luminance control unit according to whether or not the second statistical data is included in a range between an upper limit value and a lower limit value, the upper limit value and the lower limit value being determined by the first statistical data.

2. The image display control device according to claim 1, wherein:
the first statistical data is an average value of luminance of the input image, the average value being found based on the pixel values of the first image information, and
the second statistical data is an average value of the luminance values included in the backlight control information, the luminance values corresponding to the light sources.

3. An image display control device having a local dimming function, comprising:
a luminance control unit configured to generate backlight control information used for controlling a plurality of light sources included in a backlight based on first image information indicating an input image;
a pixel compensation unit configured to generate second image information indicating an output image by correcting one or more pixel values included in the first image information based on luminance of the plurality of light sources;
a first statistics acquisition unit configured to acquire first statistical data of the pixel values included in the first image information;
a second statistics acquisition unit configured to acquire second statistical data of the pixel values included in the second image information;
a third statistics acquisition unit configured to acquire third statistical data of one or more luminance values included in the backlight control information, the luminance values corresponding to the light sources; and
an abnormality detection unit configured to detect an abnormality of the luminance control unit according to whether or not output statistical data acquired based on the second statistical data and the third statistical data is included in a range between an upper limit value and a lower limit value, the upper limit value and the lower limit value being determined by input statistical data acquired based on the first statistical data.

4. The image display control device according to claim 3, wherein:
the first statistical data is an average value of luminance of the input image, the average value being found based on the pixel values of the first image information;
the input statistical data is the first statistical data or a value found by multiplying the first statistical data by a coefficient;
the second statistical data is an average value of luminance of the output image, the average value being found based on the pixel values of the second image information;
the third statistical data is an average value of the luminance values included in the backlight control information, the luminance values corresponding to the light sources; and
the output statistical data has a value corresponding to an average value of the luminance of the input image, the value corresponding to the average value being found by multiplying the second statistical data by the third statistical data.

5. The image display control device according to claim 1, wherein the abnormality detection unit is configured to prevent a process of detecting an abnormality of the luminance control unit for a duration of at least one frame when a content of the image which is to be displayed on a display unit and indicated by the second image information is switched, or when the image display control device starts.

6. The image display control device according to claim 1, wherein, when the abnormality of the luminance control unit is detected, the abnormality detection unit is configured to cause the first image information to be output as the image second information regardless of an operation of the pixel compensation unit and cause the plurality of light sources to be turned on regardless of the operation of the luminance control unit.

7. The image display control device according to claim 3, wherein the abnormality detection unit is configured to prevent a process of detecting an abnormality of the luminance control unit for a duration of at least one frame when a content of the image which is to be displayed on a display unit and indicated by the second image information is switched, or when the image display control device starts.

8. The image display control device according to claim 3, wherein, when the abnormality of the luminance control unit is detected, the abnormality detection unit is configured to cause the first image information to be output as the second image information regardless of an operation of the pixel compensation unit and cause the plurality of light sources to be turned on regardless of the operation of the luminance control unit.

9. An image display control device having a display engine configured to perform a local dimming process and a processor configured to control an operation of the display engine,
wherein the display engine is configured to:
receive first image information indicating an image to be displayed on a display unit;
store the first image information;
generate backlight control information used for controlling a plurality of light sources included in a backlight based on the first image information;
generate second image information indicating an output image by correcting one or more pixel values included in the first image information based on luminance of the plurality of light sources;
acquire first statistical data of the pixel values included in the first image information;
acquire second statistical data of one or more luminance values included in the backlight control information, the luminance values corresponding to the light sources; and
output the second image information to the display unit,
wherein the processor is configured to detect an abnormality in a generation process of the backlight control information according to whether or not the second statistical data is included in a range of an upper limit value and a lower limit value, the upper limit value and the lower limit value being determined by the first statistical data.

10. An image display control device having a display engine configured to perform a local dimming process and a processor configured to control an operation of the display engine,
wherein the display engine is configured to:
receive first image information indicating an image to be displayed on a display unit;
store the first image information;
generate backlight control information used for controlling a plurality of light sources included in a backlight based on the first image information;
generate second image information indicating an output image by correcting one or more pixel values included in the first image information based on luminance of the plurality of light sources;
acquire first statistical data of the pixel values included in the first image information;
acquire second statistical data of the pixel values included in the second image information;
acquire third statistical data of one or more luminance values included in the backlight control information, the luminance values corresponding to the light sources; and
output the second image information t the display unit;
wherein the processor is configure to detect an abnormality in a generation process of the backlight control information according to whether or not output statistical data acquired based on the second statistical data and the third statistical data is included in a range of an upper limit value and a lower limit value, the upper limit value and the lower limit value being determined by input statistical data acquired based on the first statistical data.

11. An image display control device having a local dimming function, comprising:
a luminance control unit configured to generate backlight control information used for controlling a plurality of light sources included in a backlight based on first image information indicating an input image;
a pixel compensation unit configured to generate second image information indicating an output image by correcting one or more pixel values included in the first image information based on luminance of the plurality of light sources;
a first statistics acquisition unit configured to acquire first statistical data of one or more luminance values included in the backlight control information, the luminance values corresponding to the light sources; and
an abnormality detection unit configured to detect an abnormality of the luminance control unit according to whether or not the first statistical data is included in a range of an upper limit value and a lower limit value, the upper limit value and the lower limit value being determined by an image to be displayed.

12. An image display control device having a local dimming function, comprising:
a luminance control unit configured to generate backlight control information used for controlling a plurality of light sources included in a backlight based on first image information indicating an input image;
a pixel compensation unit configured to generate second image information indicating an output image by correcting one or more pixel values included in the first image information based on luminance of the plurality of light sources;
a first statistics acquisition unit configured to acquire first statistical data of the pixel values included in the second image information;
a second statistics acquisition unit configured to acquire second statistical data of one or more luminance values included in the backlight control information, the luminance values corresponding to the light sources; and
an abnormality detection unit configured to detect an abnormality of the luminance control unit according to whether or not output statistical data acquired based on the first statistical data and the second statistical data is included in a range of an upper limit value and a lower limit value, the upper limit value and the lower limit value being determined by an image to be displayed.

13. An image display system comprising:
the image display control device according to claim 1;
a display unit;
the backlight disposed to face the display unit; and
a head unit configured to generate an image and output the first image information indicating a generated image to the image display control device.

14. An image display system comprising:
the image display control device according to claim 3;
a display unit;
the backlight disposed to face the display unit; and
a head unit configured to generate an image and output the first image information indicating a generated image to the image display control device.

15. An image display control method by an image display control device having a local dimming function, comprising:
generating, by a luminance control unit included in the image display control device, backlight control information used for controlling a plurality of light sources included in a backlight based on first image information indicating an input image;
generating, by a pixel compensation unit included in the image display control device, second image information indicating an output image by correcting one or more pixel values included in the first image information based on luminance of the plurality of light sources;
acquiring, by a first statistics acquisition unit included in the image display control device, first statistical data of the pixel values included in the first image information;
acquiring, by a second statistics acquisition unit included in the image display control device, second statistical data of one or more luminance values included in the backlight control information, the luminance values corresponding to the light sources; and
detecting by an abnormality detection unit included in the image display control device, an abnormality of the luminance control unit according to whether or not the second statistical data is included within a range between an upper limit value and a lower limit value, the upper limit value and the lower limit value being determined by the first statistical data.

16. An image display control method by an image display device having a local dimming function, comprising:
generating, by a luminance control unit included in the image display control device, backlight control information used for controlling a plurality of light sources included in a backlight based on first image information indicating an input image;
generating, by a pixel compensation unit included in the image display control device, second image information indicating an output image by correcting one or more pixel values included in the first image information based on luminance of the plurality of light sources;
acquiring, by a first statistics acquisition unit included in the image display control device, first statistical data of the pixel values included in the first image information;
acquiring, by a second statistics acquisition unit included in the image display control device, second statistical data of the pixel values included in the second image information;
acquiring, by a third statistics acquisition unit included in the image display control device, third statistical data of one or more luminance values included in the backlight control information, the luminance values corresponding to the light sources; and
detecting, by an abnormality detection unit included in the image display control device, an abnormality of the luminance control unit according to whether or not output statistical data acquired based on the second statistical data and the third statistical data is included in a range of an upper limit value and a lower limit value, the upper limit value and the lower limit value being determined by input statistical data acquired based on the first statistical data.
